(19) United States
(12) Patent Application Publication
(10) Pub. No.: US 2010/0053166 A1
(43) Pub. Date: Mar. 4, 2010

(54) INFORMATION PROCESSING APPARATUS, AND SUPER-RESOLUTION ACHIEVEMENT METHOD AND PROGRAM

(75) Inventor: Yasuyuki Tanaka, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/392,881

(22) Filed: Feb. 25, 2009

(30) Foreign Application Priority Data
Aug. 29, 2008 (JP) 2008-221474

(51) Int. Cl. G06T 5/00; G09G 5/00

(52) U.S. Cl. 345/428; 345/611

(57) ABSTRACT

According to one embodiment, an information processing apparatus includes a control module configured such that, when an angles calculated are predetermined angles, processing by a processing module is not performed on blocks corresponding to the predetermined angles, and when the angles calculated are angles other than the predetermined angle, the processing by the processing module is performed on blocks corresponding to the angles other than the predetermined angles.

### CROSS-REFERENCE TO RELATED APPLICATIONS

This application is based upon and claims the benefit of priority from Japanese Patent Application No. 2008-221474, filed Aug. 29, 2008, the entire contents of which are incorporated herein by reference.

### BACKGROUND

1. Field

One embodiment of the present invention relates to an information processing apparatus for performing super-resolution achievement processing, and in particular to an information processing apparatus configured to be capable of reducing processing load, and a super-resolution achievement method and program.

2. Description of the Related Art

Generally, in an apparatus such as a computer or a television apparatus, products equipped with a display apparatus configured to be capable of performing display with high resolution, such as high-definition television are increasing. On the other hand, regarding a content source, many content sources with low resolution lower than the resolution of the display apparatus are provided. Therefore, needs for a technology that, even if these content sources with low resolution are reproduced in the abovementioned display apparatus with high resolution, reproduction can be performed with quality close to that of the content sources with high resolution are increasing For example, Jpn. Pat. Appln. KOKAI Publication No. 2007-305113 discloses a technology of producing a content source with high resolution from a content source with low resolution utilizing image processing.

In the technology disclosed in Jpn. Pat. Appln. KOKAI Publication No. 2007-305113, however, since processing for achieving high resolution is applied to all pixel data contained in the content source with low resolution, such a problem arises that load for the processing is large.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a main configuration of an information processing apparatus according to an embodiment of the present invention;

FIG. 2 is an exemplary block diagram showing a function configuration of a computer according to the embodiment;

FIG. 3 is an exemplary flowchart showing a super-resolution achievement method applied with the information processing apparatus according to the embodiment;

FIG. 4 is an exemplary flowchart showing a method for edge determination processing and refinement processing according to the embodiment;

FIG. 5 is an exemplary diagram illustratively showing a concept of each frame of video data input into the computer according to the embodiment;

FIG. 6 is an exemplary diagram illustratively showing a concept of pixels within a base frame input into the computer according to the embodiment;

FIG. 7 is an exemplary diagram illustratively showing a concept of detecting an edge using pixels of 3×3 processed in the computer according to the embodiment;

FIG. 8 is an exemplary diagram illustratively showing a concept of angles at which pixels processed by the computer according to the embodiment are positioned;

FIG. 9 is an exemplary diagram illustratively showing a concept of a parameter used when super-resolution achievement processing using pixels of 3×3 is performed in the computer according to the embodiment;

FIG. 10 is an exemplary diagram illustratively showing a concept of detecting an edge using pixels of 5×5 to be processed in the computer according to the embodiment; and

FIG. 11 is an exemplary diagram illustratively showing a concept of a parameter used when super-resolution achievement processing using pixels of 5×5 is performed in the computer according to the embodiment.

### DETAILED DESCRIPTION

Various embodiments according to the invention will be described hereinafter with reference to the accompanying drawings. In general, according to one embodiment of the invention, an information processing apparatus provided with a processing module configured to arrange a plurality of pixels within a screen, acquire an image representing luminance of each pixel as a pixel value from an image source, sequentially set a plurality of pixels in at least one frame included in the image as target pixels one by one utilizing one frame contained in the image as a base frame, set, for each the target pixel, a target image region including the target pixel, perform self-congruity point extraction processing for searching a plurality of corresponding points corresponding to a plurality of target image regions nearest a change pattern of pixel values contained in the target image region from the base frame, and perform sharpness enhancement processing after performing the self-congruity point extraction processing, includes: a first setting module configured to set a unit including at least one pixel of pixels contained in the base frame as a base block; a second setting module configured to set pixels disposed around the base block to all pixels contained in the base frame as a plurality of blocks comprising pixels of the same number as the number of pixels contained in the base block; a calculation module configured to calculate angles at which the plurality of blocks are arranged, respectively, on the basis of the base block; a control module configured such that, when the angles calculated are predetermined angles, processing by the processing module is not performed on blocks corresponding to the predetermined angles, and when the angles calculated are angles other than the predetermined angle, the processing by the processing module is performed on blocks corresponding to the angles other than the predetermined angles.

Embodiments of the present invention will be explained below with reference to the drawings.

Referring to FIG. 1, first, a configuration of an information processing apparatus according to an embodiment of the present invention will be explained.

The information processing apparatus is accomplished as a personal computer, for example. The computer is provided with a central processing unit (CPU) 10, a graphics processing unit (GPU) 11, a network controller 12, an image processing IC 13, a storage apparatus (HDD) 15, a display apparatus (liquid crystal display [LCD]) 16, and the like.

The CPU 10 is a processor provided for controlling an operation of the computer, and it executes an operating system (OS) and various application programs loaded from a storage apparatus (HDD) 15 to a main memory.

The CPU 10 executes a system Basic Input-Output System (BIOS) stored in a BIOS-ROM. The system BIOS is a program for hardware control.

The GPU 11 is a display controller configured to control the LCD 16 used as a display monitor of the computer. The GPU 11 produces display signals to be fed to the LCD 16 from image data written in a video memory (VRAM).

The network controller 12 is a controller device configured to control transmission and reception of data between the same and an external network such as a local area network (LAN) or the Internet.

The image processing IC (processing module) 13 is a dedicated IC for image processing configured to perform coding processing, decoding processing, super-image processing of input image signals or the like. In the super-image processing, edge determination processing, refinement processing, self-congruity extraction processing, sharpness enhancement processing, virtual high-resolution image production processing, and the like are performed. It should be noted that when the computer does not include the image processing IC 13, processing to be performed by the image processing IC 13 may be performed in the CPU 10 or the like.

The storage apparatus (HADD) 15 stores an operating system (OS) and various application programs therein. Further, the storage apparatus (HDD) 15 stores table data of various parameters used in the super-image processing and the like therein. The display apparatus 16 is a display device corresponding to display of content data with high resolution, such as a high-definition television image. Of course, the display apparatus 16 can also display content data with low resolution lower than content data with high resolution, such as a high-definition television image.

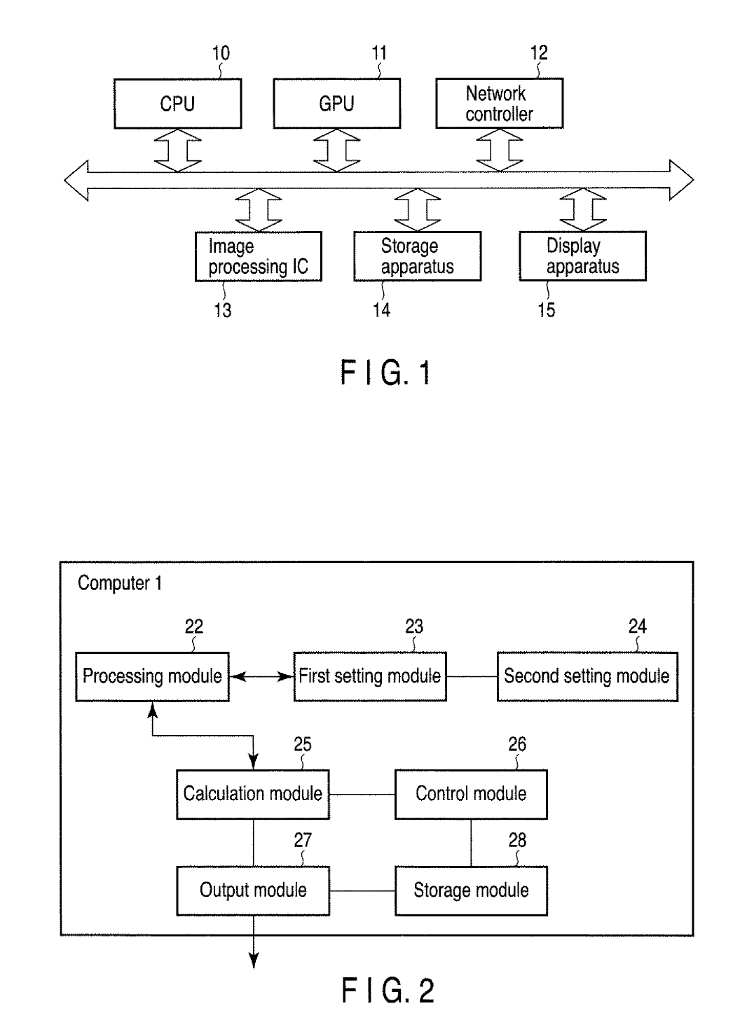

FIG. 2 is a block diagram showing a function configuration of a computer.

The computer 1 is provided with a processing module 22, a first setting module 23, a second setting module 24, a calculation module 25, a control module 26, an output module 27, and a storage module 28.

The processing module 22 performs self-congruity extraction processing and sharpness enhancement processing after performing the self-congruity extraction processing. The first setting module 23 sets a unit including at least one pixel of pixels contained in a base frame as a base block. The second setting module 24 sets pixels arranged around the base block as a plurality of blocks comprising pixels of the same number as the number of pixels contained in the base block to all pixels contained in the base frame. The calculation module 25 calculates angles at which the plurality of blocks is disposed respectively on the basis of the base block. The control module 26 performs control such that, when the calculated angles are predetermined angles (for example, values at 90° intervals including zero degree), processing by the processing module 22 is not applied to blocks corresponding to the predetermined angles but when the calculated angles are angles other than the predetermined angles, blocks corresponding thereto are processed by the processing module 22. The output module 27 outputs image sources processed by the processing module 22 to the display apparatus 16 such as LCD. The storage module 28 stores the image sources, image data which has been applied with the super-resolution achievement processing, and the like therein.

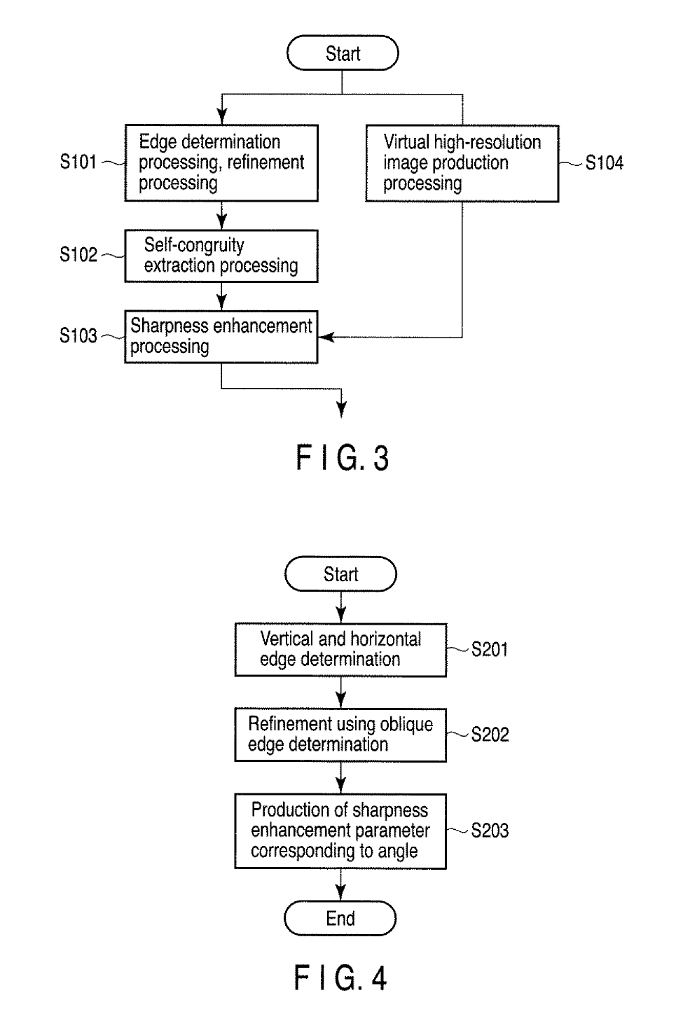

The super-resolution achievement method applied with the computer which is the information processing apparatus according to the embodiment thus configured will be explained with reference to a flowchart shown in FIG. 3. The super-resolution achievement processing is processing for improving a resolution of input video data (image source).

Video data input into the computer is subjected to edge determination processing and refinement processing performed by the image processing IC 13 (block S101).

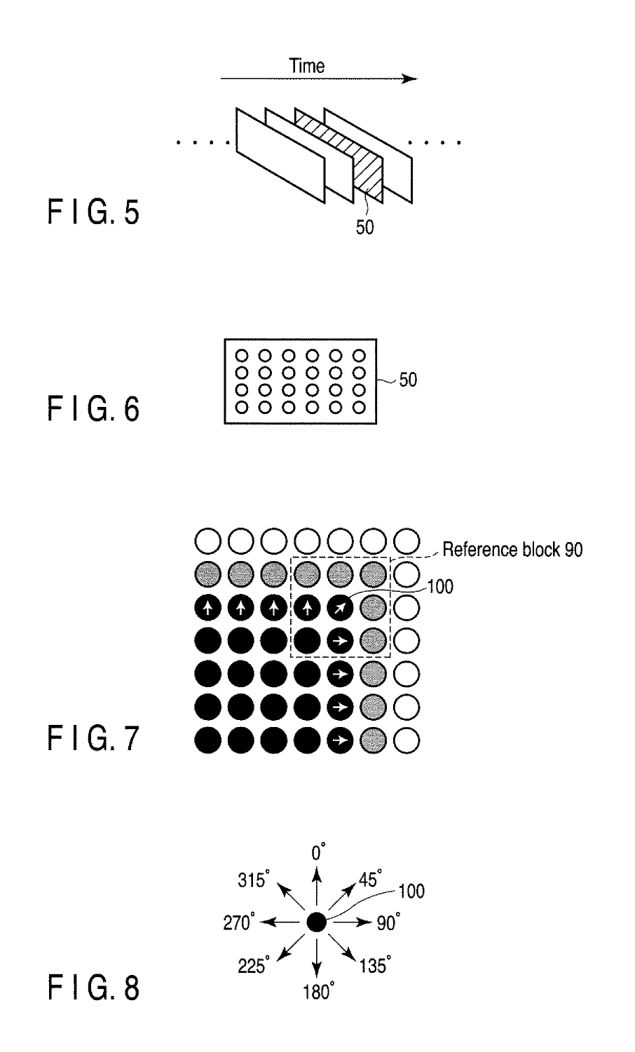

The edge determination processing and the refinement processing are performed in the following manner. For example, a plurality of pixels are arranged within a screen of video data and an image representing luminance of each pixel as a pixel value is acquired from the image source. As shown in FIG. 5, a plurality of frames is contained in the image. One frame contained in the image is utilized as a base frame 50 (see FIG. 5). As shown in FIG. 6, a plurality of pixels is contained in the base frame 50.

A plurality of pixels in at least one frame contained in the video data (image source: herein, called “image”) is sequentially set as target pixels 100, respectively (see FIG. 7) and a reference block (target image region) 90 including each target pixel 100 is set for the target pixel 100, so that an edge is determined (described later, see FIG. 4).

The image processing IC 13 searches a plurality of corresponding points corresponding to a plurality of target image regions nearest a change pattern of pixel values contained in the reference block 90 from the base frame 50 to perform self-congruity point extraction processing (block S102).

After performing the self-congruity point extraction processing, the image processing IC 13 performs sharpness enhancement processing (block S103). Simultaneously, the image processing IC 13 performs virtual high-resolution image production processing (block S104). It should be noted that the self-congruity point extraction processing, the sharpness enhancement processing, the virtual high-resolution image production processing, and the like are explained in detail in Jpn. Pat. Appln. KOKAI Publication No. 2007-310837.

Regarding the sequence of processing, the number of processing times (for example, twice, four times, or the like) of the self-congruity point extraction processing in block S102 and the sharpness enhancement processing in block S103 is set based upon the edge determination processing and the refinement processing which have been performed in block S101. If the number of processing times is zero, the self-congruity point extraction processing in block S102 and the sharpness enhancement processing in block S103 are not performed. Thereby, while suppressing degradation of image quality, the number of processing times can be reduced and the processing load can be reduced.

Next, a calculation method of the result of the edge determination processing and the refinement processing which have been performed in block S101 will be explained with reference to a flowchart shown in FIG. 4.

The image processing IC (the first setting module) 13 sets a unit including at least one pixel of pixels contained in the base frame 50 as a base block. For example, the base block is defined as one pixel (target pixel 100).

Next, the image processing IC (second setting module) 13 sets pixels arranged around the base block (target pixel 100) (for example, pixels of 3×3 surrounded by a dotted line as the reference block 90) as a plurality of blocks comprising pixels of the same number as the number of base blocks (target pixel 100) (here, since the base block comprises one pixel, each block also comprises one pixel). The above-mentioned setting is applied to all pixels contained in the base frame 50.

Next, the image processing IC (calculation module) 13 calculates angles at which a plurality of blocks (for example, pixels of 3×3 surrounded by a dotted line as the reference block 90) are disposed, respectively, on the basis of the base block (target pixel 100). For example, as shown in FIG. 8, angles at which 8 pixels surrounded by a dotted line as the base block 90 which are a plurality of blocks are disposed, respectively, are represented in the following manner. For example, a pixel positioned upwardly from the base block (target pixel 100) is determined to be positioned at an angle of 0° from the base block (target pixel 100). Subsequently, angles at which the remaining seven pixels are arranged are determined to be positioned at angles of 45°, 90°, 135°, 180°, 225°, 270°, and 315° from the base block (target pixel 100) in a clockwise direction (block S S201 and S202). This processing first determines vertical and horizontal edges (block S201), subsequently performs the refinement processing, and determines oblique edges other than the vertical and horizontal edges (block S202).

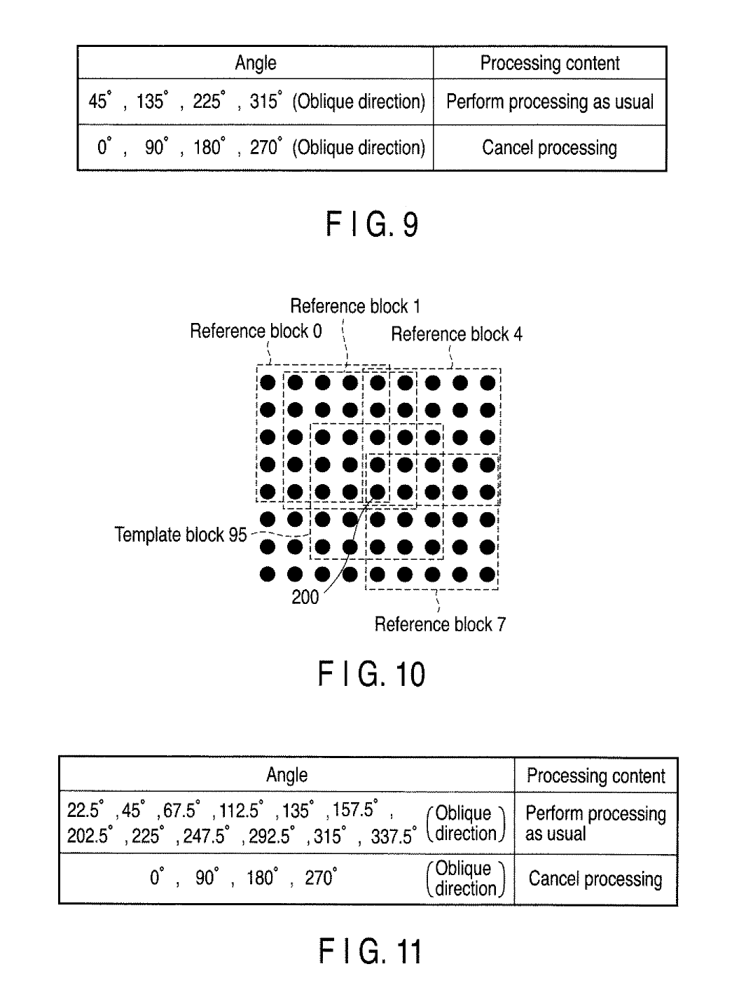

When the angles calculated by the image processing IC 13 are predetermined angles (for example, values at 90° intervals Including zero degree), the processing (the self-congruity point extraction processing and the sharpness enhancement processing) are not performed on blocks corresponding to the abovementioned angles, but when the angles calculated by the image processing IC 13 are angles other than the predetermined angles, the processing (the self-congruity point extraction processing and the sharpness enhancement processing) are performed on blocks corresponding to the angles other than the predetermined angles. For example, the predetermined angles (parameter: which is stored in the storage apparatus 15 in advance) include 0° and multiples of 90° (90°, 180°, and 270°: values at 90° intervals, including zero degree). The self-congruity point extraction processing (block S102) and the sharpness enhancement processing (block S103) shown in FIG. 2 are not performed to pixels which have been determined to be set at these angles. Even if this processing to vertical and horizontal edges is skipped, degradation of image quality does not occur so much, so that the self-congruity point extraction processing and the sharpness enhancement processing are not performed, which results in reduction of processing load. It should be noted that the abovementioned parameter is stored in the storage apparatus 15, for example, as shown in FIG. 9, and the image processing IC 13 determines processing content (whether or not the self-congruity point extraction processing and the sharpness enhancement processing are performed) referring to the parameter based upon determined angles (block S203). It should be noted that when the self-congruity point extraction processing and the sharpness enhancement processing are performed (for example, the calculated angles are determined to be angles other than 0° and multiples of 90°), the number of processing times (for example, zero, twice, four times, and the like) is stored in the abovementioned parameter and the processing is performed using this parameter. For example, when the number of processing times is two, for example, each of the self-congruity extraction processing and the sharpness enhancement processing is performed twice.

In view of these circumstances, an object of the present invention is to provide an information processing apparatus configured to be capable of reducing processing load for achieving super-resolution, and a super-resolution achievement method and program.

Thus, even if the self-congruity extraction processing and the sharpness enhancement processing to the vertical and horizontal edges are skipped, degradation of image quality is suppressed so that processing load can be reduced without performing this processing.

As a modified example, the following aspect is proposed.

In the abovementioned embodiment, regarding pixels of 3×3 surrounded by a dotted line as the reference block 90, angles at which the respective pixels are disposed have been calculated, but, for example, regarding pixels of 5×5 surrounded by a dotted line as the reference block, angles at which respective blocks are arranged are calculated in this modified example.

For example, as shown in FIG. 10, the image processing IC 13 sets a template block 95 (corresponding to the base block according to the abovementioned embodiment) including pixels of 5×5. A central pixel in the template block 95 is a target pixel 200.

Next, the image processing IC 13 sets pixels of 5×5 arranged around the template block 95 with a central focus on the target pixel 200 of the template block 95 as a reference block 0.

The abovementioned setting is performed to all pixels arranged around the template block 95 to set reference blocks 0 to 10.

Next, the image processing IC 13 calculates angles at which the reference blocks 0 to 13 are arranged on the basis of the template block 95. As shown in FIG. 11, for example, angles of 315° (reference block 0), 337.5° (reference block 1), 0° (reference block 2), 22.5° (reference block 3), 450 (reference block 4), 67.5° (reference block 5), 9Q0 (reference block 6), 112.5° (reference block 7), 1350 (reference block 8), 157.5° (reference block 9), 180° (reference block 10), 202.5° (reference block 11), 225° (reference block 12), 247.5° (reference block 13), 2700 (reference block 14), and 292.5° (reference block 15) are determined (calculated).

The abovementioned self-congruity extraction processing and sharpness enhancement processing are not performed to pixels where angles calculated by the image processing IC 13 are determined to be 0° and multiples of 90° (90°, 180°, 270°), for example.

According to the modified example, determination of pixels can be performed in more detail as compared with the abovementioned embodiment, so that image quality can be improved.

In view of these circumstances, an object of the present invention is to provide an information processing apparatus configured to be capable of reducing processing load for achieving super-resolution, and a super-resolution achievement method and program.

It should be noted that since all the procedures of the control processing of the embodiment can be accomplished by software, an effect similar to that of the embodiment can be obtained easily by simply installing a program executing this procedure in a computer having an optical disk drive provided with a power saving operation mode through a computer-readable storage medium. The abovementioned module can be accomplished as software or hardware.

A module can be accomplished in software and hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus provided with a processing module configured to arrange a plurality of pixels within a screen, acquire an image representing luminance of each pixel as a pixel value from an image source, sequentially set a plurality of pixels in at least one frame included in the image as target pixels one by one utilizing one frame contained in the image as a base frame, set, for each the target pixel, a target image region including the target pixel, perform self-congruity point extraction processing for searching a plurality of corresponding points corresponding to a plurality of target image regions nearest a change pattern of pixel values contained in the target image region from the base frame, and perform sharpness enhancement processing after performing the self-congruity point extraction processing, comprising:
a first setting module configured to set a unit including at least one pixel of pixels contained in the base frame as a base block;
a second setting module configured to set pixels disposed around the base block to all pixels contained in the base frame as a plurality of blocks comprising pixels of the same number as the number of pixels contained in the base block;
a calculation module configured to calculate angles at which the plurality of blocks are arranged, respectively, on the basis of the base block;
a control module configured such that, when the angles calculated are predetermined angles, processing by the processing module is not performed on blocks corresponding to the predetermined angles, and when the angles calculated are angles other than the predetermined angle, the processing by the processing module is performed on blocks corresponding to the angles other than the predetermined angles.

2. The information processing apparatus of claim 1, wherein
the predetermined angles are values at 90° intervals including zero degrees.

3. The information processing apparatus of claim 1, further comprising a storage module storing the number of processing times of the self-congruity point extraction processing and the sharpness enhancement processing corresponding to the angles calculated by the calculation module therein in advance, wherein
the processing module performs the self-congruity point extraction processing and the sharpness enhancement processing based upon the number of processing times stored in the storage module.

4. A super-resolution achievement method used in an information processing apparatus provided with a processing module configured to arrange a plurality of pixels within a screen, acquire an image representing luminance of each pixel as a pixel value from an image source, sequentially set a plurality of pixels in at least one frame included in the image as target pixels one by one utilizing one frame contained in the image as a base frame, set, for each the target pixel, a target image region including the target pixel, perform self-congruity point extraction processing for searching a plurality of corresponding points corresponding to a plurality of target image regions nearest a change pattern of pixel values contained in the target image region from the base frame, and perform sharpness enhancement processing after performing the self-congruity point extraction processing, comprising:
setting a unit including at least one pixel of pixels contained in the base frame as a base block;
setting pixels disposed around the base block to all pixels contained in the base frame as a plurality of blocks comprising pixels of the same number as the number of pixels contained in the base block;
calculating angles at which the plurality of blocks are arranged, respectively, on the basis of the base block;
when the angles calculated are predetermined angles, cancelling processing by the processing module on blocks corresponding to the predetermined angles and when the angles calculated are angles other than the predetermined angles, performing the processing by the processing module on blocks corresponding to the angles other than the predetermined angles.

5. The super-resolution achievement method of claim 4, wherein
the predetermined angles are values at 90° intervals including zero degree.

6. The super-resolution achievement method of claim 4, wherein
the information processing apparatus further comprising a storage module storing the number of processing times of the self-congruity point extraction processing and the sharpness enhancement processing corresponding to the angles calculated by the calculation module therein in advance, and
the processing module performs the self-congruity point extraction processing and the sharpness enhancement processing based upon the number of processing times stored in the storage module.

7. A storage medium storing a program used in an information processing apparatus, the information processing apparatus provided with a processing module configured to arrange a plurality of pixels within a screen, acquire an image representing luminance of each pixel as a pixel value from an image source, sequentially set a plurality of pixels in at least one frame included in the image as target pixels one by one utilizing one frame contained in the image as a base frame, set, for each of the target pixels, a target image region including the target pixel, perform self-congruity point extraction processing for searching a plurality of corresponding points corresponding to a plurality of target image regions nearest a change pattern of pixel values contained in the target image region from the base frame, and perform sharpness enhancement processing after performing the self-congruity point extraction processing, causing a computer to execute:
a first setting procedure of setting a unit including at least one pixel of pixels contained in the base frame as a base block;
a second setting procedure of setting pixels disposed around the base block to all pixels contained in the base frame as a plurality of blocks comprising pixels of the same number as the number of pixels contained in the base blocks;
a calculation procedure of calculating angles at which the plurality of blocks are arranged, respectively, on the basis of the base block; and
a processing procedure that, when the angles calculated are predetermined angles, processing by the processing module is not performed on blocks corresponding to the predetermined angles and when the angles calculated are angles other than the predetermined angles, the processing by the processing module is performed on blocks corresponding to the angles other than the predetermined angles.
